(19) United States
(12) Patent Application Publication
(10) Pub. No.: US 2007/0290976 A1
(43) Pub. Date: Dec. 20, 2007

(54) LIQUID CRYSTAL DISPLAY DEVICE

(75) Inventors: Midori Tsukane, Ishikawa (JP); Kenji Nakao, Ishikawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/760,950

(22) Filed: Jun. 11, 2007

(30) Foreign Application Priority Data
Jun. 14, 2006 (JP) 2006-165271

(51) Int. Cl. G09G 3/36

(52) U.S. Cl. 345/94

(57) ABSTRACT

An object is to provide an OCB-mode liquid crystal display device causing no flicker even with varying environment temperature, and flicker prevention is offered by dividing a transition voltage to that of a first pulse and that of a latter pulse, and varying a ratio of pulse width of a transition voltage, i.e., between the first pulse and the latter pulse, together with any detected environment temperature.

### CROSS-REFERENCE TO RELATED APPLICATIONS

This application is based upon and claims the benefit of priority from the prior Japanese Patent Application No. 2006-165271, filed on Jun. 14, 2006; the entire contents of which are incorporated herein by reference.

### TECHNICAL FIELD

The present invention relates to a liquid crystal display device for use with a liquid crystal television, a liquid crystal monitor, and others.

### BACKGROUND OF THE INVENTION

A TN (Twisted Nematic)—mode liquid crystal display device has been popular for use, but recently proposed is an OCB-mode (Optically Compensated Bend)—mode liquid crystal display device characterized in high-speed response. As an example, refer to Technical Report of Institute of Electrical and Electronics Engineers, EDI 98-144, pp. 199.

In such an OCB-mode liquid crystal display device, an OCB-mode liquid crystal material is sandwiched between substrates, and the substrates are each formed thereon with a transparent electrode for use as voltage application means. Before the liquid crystal display device is turned on, the liquid crystal material is in the state called splay-aligned. When the liquid crystal display device is turned on, for example, a relatively high voltage is applied to the voltage application means in a short time to change the alignment of the liquid crystal material from splay to bend. Performing display with the bend alignment is the characteristics of the OCB-mode liquid crystal display mode. Due to such alignment transition, the waveform of a voltage is large compared with that of a voltage during display, thereby requiring long-time voltage application and showing DC (Direct Current) tendency. The electric potential is thus allocated to two polarities, i.e., positive and negative, to derive alternating tendency, and the period of voltage application for the polarities is optimized based on the environment temperature or others not to cause flicker with DC remained during display immediately after the waveform change due to alignment transition. As an example, refer to Japanese Application Kokai 2002-6284.

By referring to FIG. 6, such an OCB-mode liquid crystal display device is described in more detail.

In the OCB-mode liquid crystal display device, a liquid crystal material 101 is sandwiched between an array substrate 102 and another substrate 102 opposing thereto. The OCB-mode liquid crystal display device is provided with, at the outside of these substrates, a phase difference plate 103 and a polarizer plate 104. In this configuration, the substrates 102 and 102 are both subjected to alignment, and liquid crystal molecules are subjected to parallel alignment to be aligned as shown in the drawing. In the state with no voltage application, the liquid crystal material is splay-aligned (FIG. 6A), and this splay alignment is changed to bend alignment for display use (FIG. 6B). For such alignment transition, a relatively high transition voltage, e.g., about 25V, is applied to a liquid crystal layer.

The issue here is that the occurrence of flicker due to DC varies depending on the ion type or amount in a liquid crystal panel, and if environment temperature varies, the ion drift speed also varies. As such, there has been a problem of causing flicker if an environment temperature is different from the temperature used for waveform optimization for alignment transition.

### BRIEF SUMMARY OF THE INVENTION

In consideration of the above problems, an object of the present invention is to provide an OCB-mode liquid crystal display device causing no flicker even with varying environment temperature.

According to embodiments of the present invention, an embodiment is directed to a liquid crystal display device, including: an OCB-mode liquid crystal panel; a temperature detection unit that detects the temperature of an area around the liquid crystal panel; and a transition voltage application unit that applies a transition voltage of transiting the alignment of a liquid crystal material of the OCB-mode liquid crystal panel from splay to bend. In the liquid crystal display device, the transition voltage in the transition voltage application unit is configured by a first pulse and a latter pulse having different polarities, and a ratio L2/L1 of a width L1 of the first pulse and a width L2 of the latter pulse is decreased in value with an increase of the temperature being a detection result by the temperature detection unit.

Another embodiment is directed to a liquid crystal display device, including: an OCB-mode liquid crystal panel; a temperature detection unit that detects the temperature of an area around the liquid crystal panel; and a transition voltage application unit that applies a transition voltage of transiting the alignment of a liquid crystal material of the OCB-mode liquid crystal panel from splay to bend. In the liquid crystal display device, the transition voltage in the transition voltage application unit is configured by a first pulse and a latter pulse having different polarities, and a ratio |V2|/|V1| of an absolute value |V1| of a voltage value V1 of the first pulse and an absolute value |V2| of a voltage value V2 of the latter pulse is decreased in value with an increase of the temperature being a detection result by the temperature detection unit.

Still another embodiment is directed to a liquid crystal display device, including: an OCB-mode liquid crystal panel; a temperature detection unit that detects the temperature of an area around the liquid crystal panel; and a transition voltage application unit that applies a transition voltage of transiting the alignment of a liquid crystal material of the OCB-mode liquid crystal panel from splay to bend. In the liquid crystal display device, the transition voltage in the transition voltage application unit is configured by a first pulse and a latter pulse having different polarities, and a ratio S2/S1 of an integral value S1 of the first pulse and an integral value S2 of the latter pulse is decreased in value with an increase of the temperature being a detection result by the temperature detection unit.

According to the present invention, flicker prevention can be achieved by changing a first pulse and a latter pulse of a transition voltage based on any detected temperature.

### BRIEF DESCRIPTION OF THE DRAWINGS

FIG. 1 is a block diagram showing a first embodiment of a liquid crystal display device of the present invention;

FIG. 2 is a waveform diagram of a transition voltage in the first embodiment;

FIG. 3 is a table showing an environment temperature, the width of a first pulse, the width of a latter pulse, and a ratio of pulse width;

FIG. 4 is a plot graph of the relationship between the environment temperature and the ratio of pulse width between the first and latter pulses;

FIG. 5 is a graph showing the relationship between an environment temperature and a ratio of potential difference between first and latter pulses in a second embodiment; and

FIG. 6 is a diagram for illustrating the alignment transition from splay to bend.

### DETAILED DESCRIPTION OF THE INVENTION

### First Embodiment

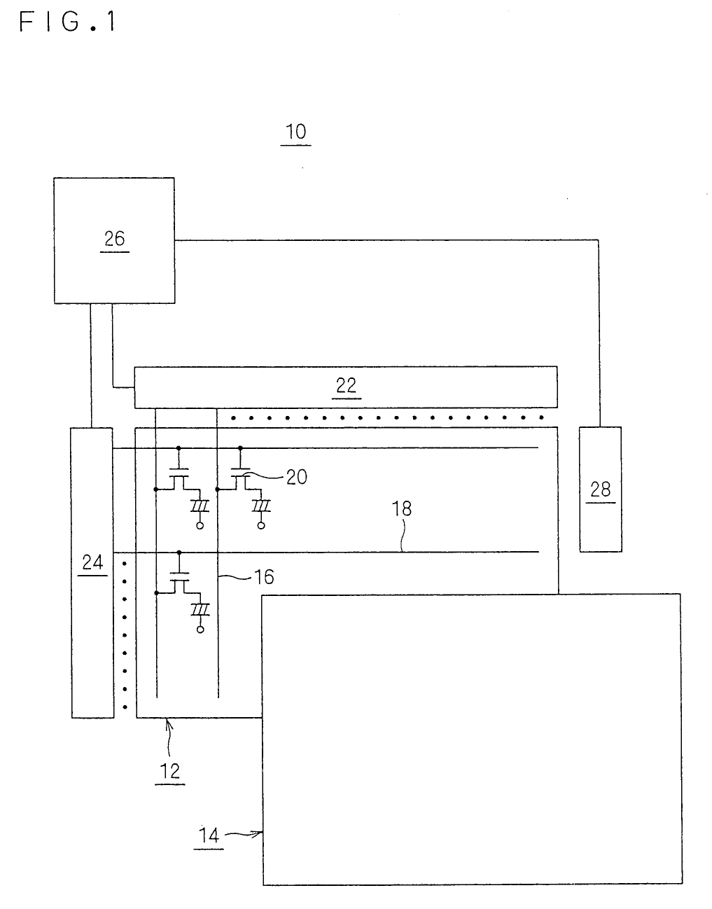

In the below, by referring to FIGS. 1 to 4, described is an OCB-mode liquid crystal display device 10 of a first embodiment of the present invention.

By referring to FIG. 1, the configuration of the liquid crystal display device 10 is described.

The liquid crystal display device 10 is provided with an array substrate 12 and an opposing substrate 14, and between the substrates 12 and 14, a liquid crystal material (liquid crystal material of an OCB-mode) is sandwiched.

The array substrate 12 is made of glass, and is formed thereon with a plurality of signal lines 16 being orthogonal to a plurality of scanning lines 18. In the vicinity of intersection portions of the signal lines 16 and the scanning lines 18, a polysilicon-made thin-film transistor (hereinafter, referred to as TFT) 20 is each formed, and pixels are disposed in a matrix. The signal lines 16 are each connected to a source electrode of the TFT 20, and the scanning lines 18 are each connected to a gate electrode of the TFT 20. A drain electrode of the TFT 20 is connected to a pixel electrode.

To the signal lines 16, a liquid crystal drive voltage being a video signal is provided from a signal line driver circuit 22, and to the scanning lines 18, a gate signal is provided from a scanning line driver circuit 24 so that the TFTs 20 are driven.

The pixels in a matrix on the array substrate 12 each have a transition core portion for use to apply a transition voltage, which is a voltage for use for alignment transition of an OCB-mode liquid crystal material from splay to bend. This transition core portion is configured by an ITO (Indium Tin Oxide) configuring a pixel electrode, and has the same electric potential as that of the pixel electrode.

Alternatively, a pixel electrode may include an electrode for forming a storage capacity, and this electrode may be coupled to the scanning line 18 in the stage preceding thereto to derive capacitive coupling.

The signal line driver circuit 22 and the scanning line driver circuit 24 are under the control of a controller 26. This controller 26 is provided with a detection temperature signal related to the detection temperature of a digital temperature sensor 28. This temperature sensor 28 is attached onto a printed wiring board to which the controller 26 is attached.

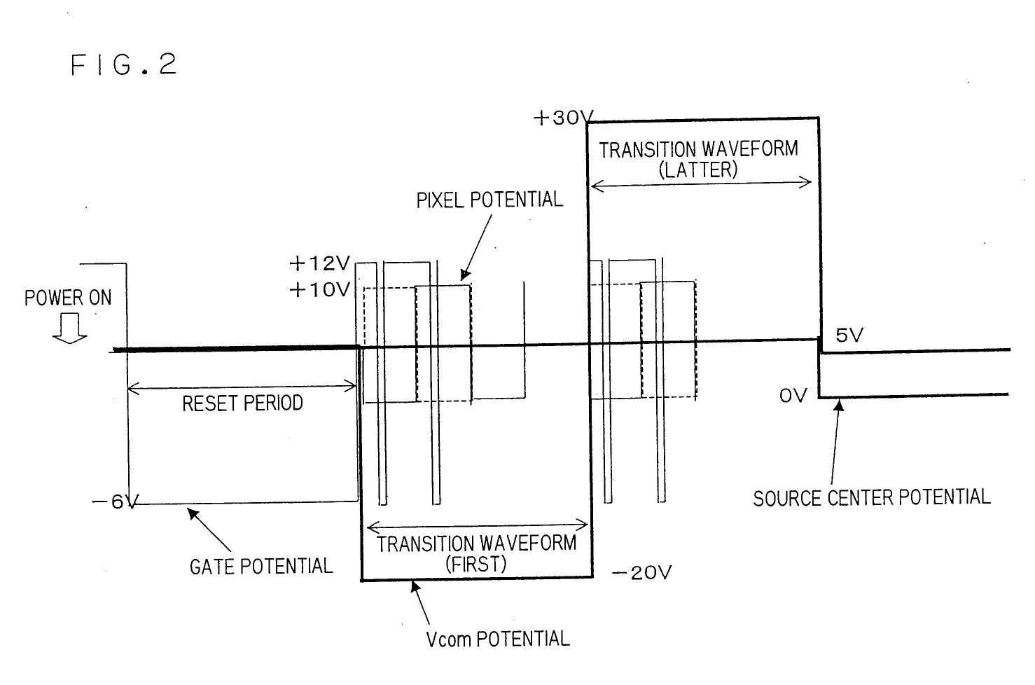

By referring to FIGS. 2 to 4, described next is a transition voltage application method.

When the liquid crystal display device 10 is turned on, a transition circuit is operated in the signal line driver circuit 22. First of all, the temperature sensor 28 detects an environment temperature, and the resulting detection temperature signal is forwarded to the controller 26. The controller 26 determines a clock count for use for the pulse transition voltage, and based thereon, determines the wavelength length for the transition voltage, i.e., for first and latter pulses respectively (pulse width of each polarity). Based on the determination result, the voltage is changed for application to an opposing electrode of the opposing substrate 14.

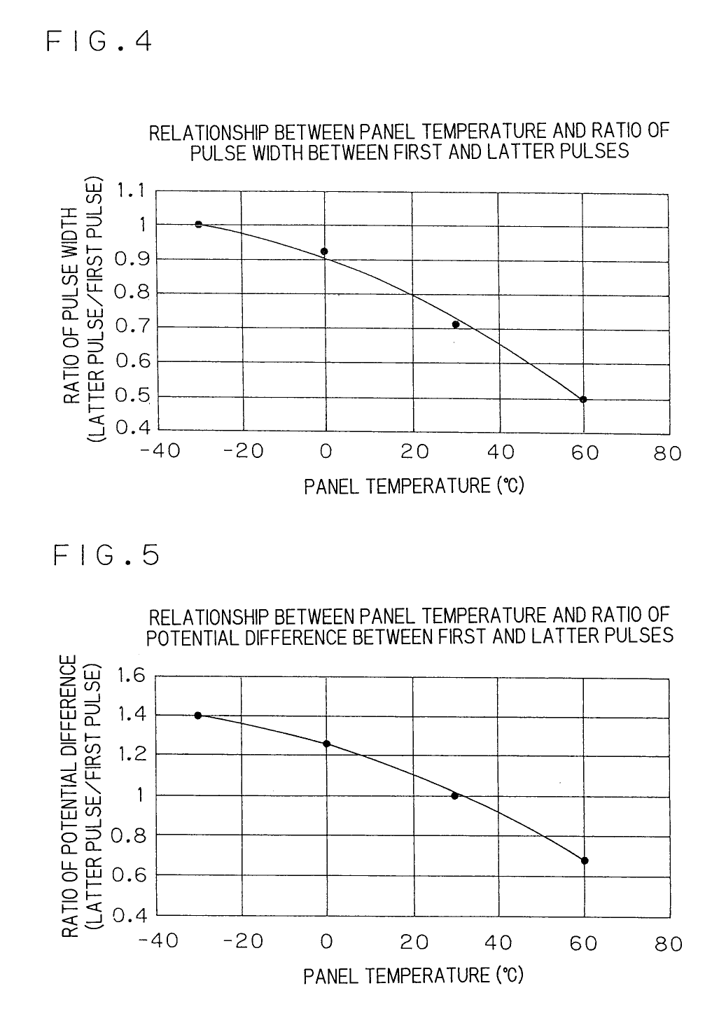

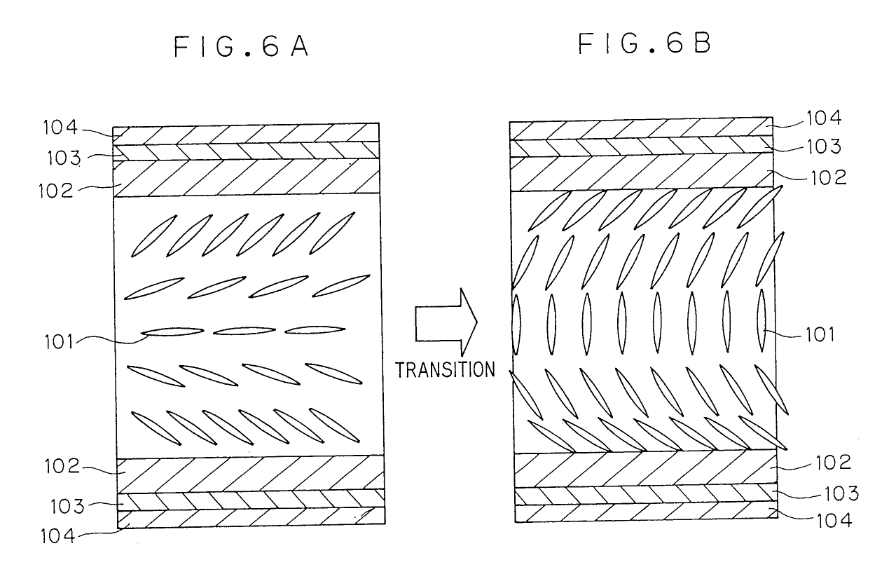

FIG. 4 is a diagram showing the state of an electric potential when the liquid crystal display device is turned on.

The source voltage is driven in a range around 5V from −7V to +7V. The gate voltage is driven in a range from −6V to +12V. After a reset period of 0.4 seconds for setting both the opposing potential and the source potential to +5V to derive the pixel potential of 0V, the voltage of −20V is applied to the opposing electrode for 0.35 seconds as a first pulse of the transition voltage, and then the voltage of +30V is applied thereto for 0.25 seconds as a latter pulse of the transition voltage.

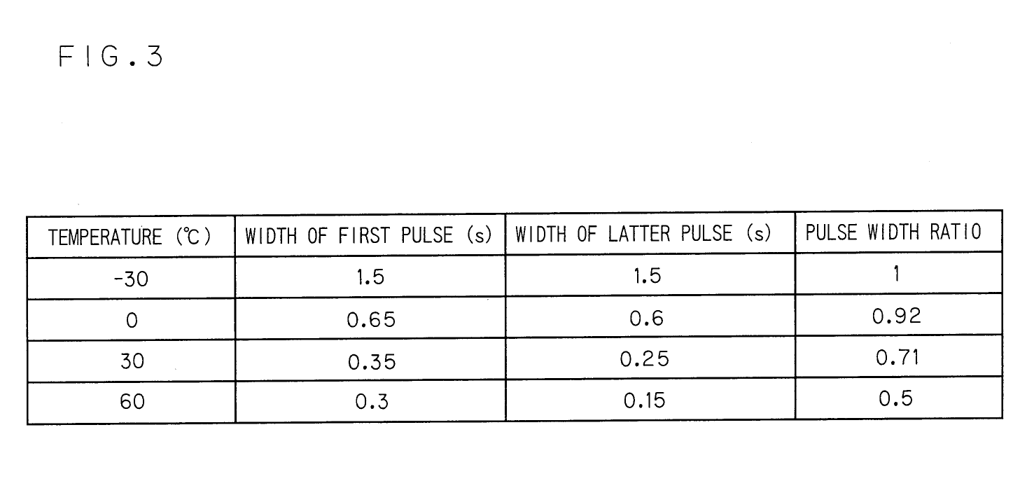

At this time, in this embodiment, the environment temperature is used as a basis to change the ratio of pulse width between the latter pulse and the first pulse, which have different polarities. That is, without changing the potential of the first pulse and that of the latter pulse, examined is the optimum waveform for the respective environment temperatures of causing no flicker after the waveform change due to alignment transition. FIG. 3 shows the results. FIG. 4 is the plot graph of the environment temperature and the ratio of pulse width between the first pulse and the latter pulse.

With the environment temperature of 0 degree centigrade, for example, no flicker is caused with the width of a first pulse being 0.65 seconds, the width of a latter pulse being 0.6 seconds, and the ratio of pulse width being 0.92. Also with the environment temperature of 30 degrees centigrade, for example, no flicker is caused with the width of a first pulse being 0.35 seconds, the width of a latter pulse being 0.25 seconds, and the ratio of pulse width being 0.71.

As such, through control exercise over the widths of the first and latter pulses based on an environment temperature, no flicker is caused with whichever environment temperature after the waveform change due to alignment transition.

### Second Embodiment

Described next is another OCB-mode liquid crystal display device 10 in a second embodiment by referring to FIG. 5.

In the first embodiment, the transition voltage is changed in ratio of pulse width between a first pulse and a latter pulse. In this embodiment, the ratio of pulse width remains the same with whichever environment temperature, and the ratio of pulse potential is changed. This is described by referring to the graph of FIG. 5. FIG. 5 is a diagram showing the relationship between absolute values of potentials of the first and latter pulses and an environment temperature.

As the transition voltage, when the potential of a first pulse is −20V (potential difference of 25V from a reference potential) and a ratio of pulse width is 0.71 between the first pulse and a latter pulse, and when a ratio of potential difference is adjusted as shown in FIG. 5 for the respective environment temperatures, the occurrence of flicker can be prevented after the waveform change due to alignment transition.

### Third Embodiment

Described next is the OCB-mode liquid crystal display device 10 in a third embodiment.

In the third embodiment, the occurrence of flicker can be prevented through control exercise, in accordance with an environment temperature, over an integral ratio in the transition voltage, i.e., between an integral value of a first pulse and that of a latter pulse. That is, a ratio is first determined between an area S1 of a first pulse and an area S2 of a latter pulse, and a setting is so made that the ratio is reduced in value with an increase of the environment temperature. For example, if the ratio S2/S1 is changed in a range from 0.5 to 1.5, the occurrence of flicker can be favorably prevented.

The present invention is not restrictive to the embodiments described above, and numerous other modifications and variations can be devised without departing from the scope of the invention.

What is claimed is:

1. A liquid crystal display device, comprising:
an OCB-mode liquid crystal panel;
a temperature detection unit that detects a temperature of an area around the liquid crystal panel; and
a transition voltage application unit that applies a transition voltage of transiting alignment of a liquid crystal material of the OCB-mode liquid crystal panel from splay to bend, wherein
the transition voltage in the transition voltage application unit is configured by a first pulse and a latter pulse having different polarities, and a ratio L2/L1 of a width L1 of the first pulse and a width L2 of the latter pulse is decreased in value with an increase of the temperature being a detection result by the temperature detection unit.

2. The liquid crystal display device according to claim 1, wherein
the ratio L2/L1 is changed in a range from 0.5 to 1.0.

3. A liquid crystal display device, comprising:
an OCB-mode liquid crystal panel;
a temperature detection unit that detects a temperature of an area around the liquid crystal panel; and
a transition voltage application unit that applies a transition voltage of transiting alignment of a liquid crystal material of the OCB-mode liquid crystal panel from splay to bend, wherein
the transition voltage in the transition voltage application unit is configured by a first pulse and a latter pulse having different polarities, and a ratio |V2|/|V1| of an absolute value |V1| of a voltage value V1 of the first pulse and an absolute value |V2| of a voltage value V2 of the latter pulse is decreased in value with an increase of the temperature being a detection result by the temperature detection unit.

4. The liquid crystal display device according to claim 3, wherein
the ratio |V2|/|V1| is changed in a range from 0.5 to 1.5.

5. A liquid crystal display device, comprising:
an OCB-mode liquid crystal panel;
a temperature detection unit that detects a temperature of an area around the liquid crystal panel; and
a transition voltage application unit that applies a transition voltage of transiting alignment of a liquid crystal material of the OCB-mode liquid crystal panel from splay to bend, wherein
the transition voltage in the transition voltage application unit is configured by a first pulse and a latter pulse having different polarities, and a ratio S2/S1 of an integral value S1 of the first pulse and an integral value S2 of the latter pulse is decreased in value with an increase of the temperature being a detection result by the temperature detection unit.

6. The liquid crystal display device according to claim 5, wherein
the ratio S2/S1 is changed in a range from 0.5 to 1.5.
